(19) United States
(12) Patent Application Publication
(10) Pub. No.: US 2002/0194895 A1
(43) Pub. Date: Dec. 26, 2002

(54) Bottle friction analysis system

(75) Inventors: Louis Thomas Germinario, Kingsport, TN (US); James Edward Moore, Kingsport, TN (US); Steven Lee Stafford, Gray, TN (US)

Correspondence Address: Mark L. Davis, P.O. Box 9293, Gray, TN, 37615-9293, US

(73) Assignee: Eastman Chemical Company, Kingsport, TN (US)

(21) Appl. No.: 10/154,300

(22) Filed: May 23, 2002

Related U.S. Application Data
(60) Provisional application No. 60/293,851, filed on May 25, 2001.

(51) Int. Cl. G01N 19/02

(52) U.S. Cl. 73/9; 73/862.21

(57) ABSTRACT

An apparatus and method for determining the coefficient of friction for plastic articles having non-planar surfaces and particularly plastic articles having irregular and arcuate surfaces, such as thermoplastic bottles or preforms utilizes a stationary sample and a rotatable sample in contact with the stationary sample. A downward force is applied to the stationary sample while applying torque to the rotatable sample. The torque applied is computer controlled and at the moment of slip is detected. The amount of torque necessary for maintaining a constant speed is also computer controlled and recorded. From the torque measurements, the computer calculates the coefficient of friction between the two sample materials.

### CROSS REFERENCE TO RELATED APPLICATIONS

Benefit is claimed to the earlier filed application having U.S. Serial No. 60/293,851 filed May 25, 2001, the entire disclosure of which is incorporated herein by reference.

### BACKGROUND OF THE INVENTION

1. Field of the Invention

This invention relates to an apparatus for measuring the frictional characteristics of plastic articles having non-planar surfaces and particularly to plastic articles having irregular and arcuate surfaces, such as thermoplastic bottles or preforms. More particularly, this invention relates to an apparatus for measuring the frictional characteristics of plastic articles using a speed and torque-sensing apparatus capable of continuously measuring the frictional characteristics of thermoplastic bottles or preforms such as containers suitable for drinks and foods, such as for example, carbonated soft drinks. Another aspect of the present invention is a method for measuring the frictional characteristics of the plastic articles.

2. Background of the Invention

The ability to measure frictional characteristics of bottle surfaces is important to the container packaging industry. Problems exist in conveying the various container types due to stretch-blow molding machines high speed rate and the need for the filling lines to keep pace with these machines. An excessive amount of static friction is encountered when two surfaces, such as the outer preform surfaces, come in contact with each other. In addition, friction between just molded preforms cause the preforms to stack during boxing operations which leads to fewer preforms being loaded into a box and higher unit shipping costs. The high surface frictional characteristics of preforms can also lead to process interruptions during the unloading of the preforms from the shipping boxes into stretch-blow molding machines. In addition, high preform friction is also reported by the industry to contribute to feeder bin jams as the preforms are loaded onto the feeder rail. The latter will give rise to production capacity problems due to process interruptions.

The following is a brief description of areas in container packaging industry where problems have been encountered due to excessive coefficient of friction (COF):

During the process of injection molding preforms, the preforms are often immediately fed into a large box (termed gaylord box) which can hold >1000 preforms. It is known by those skilled in the art that poly(ethylene terephthalate) (PET) has a high coefficient of friction, i.e., static coefficient of friction greater than 1.0. Consequently, the preforms tend to stack on top of one another in a conical shape (as viewed from the side of the box) instead of desirably sliding past one another and giving more uniform distribution within the container. As a result, fewer preforms are loaded into a box with increased handling and shipping costs.

The next step in preform processing is transferring the preforms from the box into a stretch-blow molding machine feeder bin. Typically, jams occur in the feeder bin as the preforms are loaded onto a feed rail which may also be attributed to the high level of friction between the preform surfaces.

Process interruptions are also reported during the bottle blowing process. During the process of blowing and filling stretch blow-molded PET carbonated soft drink bottles, it is common to convey bottles along conveyor belts or rails. Conveying the bottles from the stretch blow-molding machine to a palletizer area, or conversely from the depalletizer area to the labeling and filling area, requires several rows of bottles to be merged into one row and thereafter conveying the bottles in single file, and possibly using several conveying apparatuses. This convergence leads to an increased pressure between bottles as they are squeezed into a single file. The bottles squeezing alignment can lead to excessive friction between the bottles, resulting in the bottles sticking and jamming.

A method is needed for measuring the frictional properties of bottles or preforms to objectively measure resin composition improvements, additives effect on friction, and/or process improvements that lead to optimized preform and bottle coefficient of frictions. Japan Patent 10221239 to Asahi Breweries Ltd. describes an apparatus for measuring the coefficient of friction by measuring the pushing load between a conveyor and articles conveyed, such as bottles (glass or plastic) and cans. However, this apparatus cannot provide a bottle-to-bottle coefficient of friction.

ASTM Test method D 1894-99 describes a method for determining the coefficient of starting and sliding friction of plastic films and sheets in contact land sliding over itself or other substances. However, this method is only useful for measuring friction characteristics of polymers having straight or planar surfaces and is not useful for measuring frictional properties of curved or cylindrical objects.

U.S. Pat. No. 5,795,990 issued to Gitis et al. on August 18, 1998 discloses a tribology device for measuring the friction and wear characteristics of materials. The device has a stationary frame with guides, a carriage that slides along the guides, a motor with a chuck for holding a first test specimen, and a means for holding a second test specimen parallel to the longitudinal axis of the first specimen, and a measuring system for measuring the friction and wear of the test specimens in frictional contact. However, the '990 device does not allow for the testing of irregular shaped articles.

U.S. Pat. No. 6,138,496 issued to Allmann et al. on Oct. 31, 2000 discloses a device and method for determining the coefficient of friction of a material on a roller. The device includes a first roller and an unrestrained second roller for contacting the material. The rollers have an axis of rotation that is substantially parallel and non-coaxial. A torque means is coupled to the first roller to apply (i) a first torque in a first direction to the first roller to cause the material to slip relative to the first roller, and (ii) a second torque in a second direction opposite the first direction to cause the material to slip relative to the first roller. The device has a means for detecting when slip occurs and a computer for controlling the motor and calculating the coefficient of friction. The problem that the '496 patent sought to solve was to avoid damaging a web as it is transported across rollers by determining at what point slippage would occur. The '496 device does not allow for the testing of irregular shaped articles.

U.S. Pat. No. 6,349,587 issued to Mani et al. on February 26, 2002 discloses a friction testing machine for measuring the friction between a rubber specimen or a tread element and different friction surfaces at different sliding velocities, contact pressures and orientations. The machine includes a carriage, a friction surface, a motion device, a sample holder, a variable weight loading device, and a force measurement device. The force measurement device obtains a measurement indicative of the frictional force resisting movement of the sample as it is moved in the forward and reverse directions. The processor controls the motion device, controls the variable weight loading device and/or records the measurements obtained by the force measurement device.

Russian Patent (SU 1326956, Jul. 30, 1987) describes an apparatus for measuring the coefficient of slipping friction of articles with cylindrical or spherical shapes and is based on the inclined plane method described in ASTM G115 and D 3248.

Russian Patent (SU 1585733, Jul. 15, 1990) also describes an apparatus for measuring the coefficient of slipping friction of articles with cylindrical or spherical shapes that is also based on the inclined plane method described in ASTM G115 and D 3248, and includes a mechanism for rotation of plates and pressing elements.

Accordingly, there is a need for an apparatus and method to determine the frictional properties of articles having non-planar surfaces, such as stretch-blown plastic bottles that are suitable for containing drinks and foods.

### SUMMARY OF THE INVENTION

Briefly, the present invention provides an apparatus and method for determining the coefficient of friction for irregular shaped articles, such as those have a non-planar surface. Although the apparatus and method will be described herein with reference to a bottle preform or blown bottle container, one skilled in the art will understand that the apparatus can be used to measure the coefficient of friction for a variety of irregularly shaped articles. The apparatus measures bottle-to-bottle coefficient of friction and provides the maximum force required to initiate and maintain sliding motion of one bottle over another bottle.

The apparatus includes a frame for supporting and positioning bottles, a torque means and a computer for controlling the torque means and to calculate the coefficient of friction and to provide an output, such as displaying a graph, printing a report, and/or making adjustments to test parameters.

Another aspect of the present invention is a method for determining the COF for an irregularly shaped article, such as those have a non-planar surface. The method includes mounting a first bottle on the torque means of the apparatus for rotating the first bottle at a predetermined speed; contacting the rotatable first bottle with a stationary second bottle; applying a predetermined downward force on the stationary second bottle for holding the first and second bottles in intimate contact; applying and monitoring the torque applied to the first bottle at the predetermined rotational speed; and calculating the coefficient of friction.

It is an object of the present invention to provide an apparatus and method for determining the coefficient of friction for an irregular shaped article.

It is another object of the present invention to provide an apparatus and method for determining the coefficient of friction for thermoplastic preform or blow-molded bottle.

### BRIEF DESCRIPTION OF THE DRAWINGS

FIG. 1 is a perspective view of the coefficient of friction measurement apparatus in accordance with a preferred embodiment of the present invention.

FIG. 2 is a perspective view of an alternative embodiment of the measurement apparatus.

FIG. 3 is a graph of the static coefficient of friction test variability for 20 oz. bottles given in greater detail in Example 1.

FIG. 4 is a graph of the effect of bottle rotation speed (rpm) using a 500 gram load, on COF for 20 oz. bottle.

FIG. 5 is a graph of the effect of variable bottle loading (weight) at fixed bottle rotation speed, 10 rpm, on COF for 20 oz. bottles.

FIG. 6 is a graph of the effect of bottle aging time, i.e., the time a bottle is tested after forming, on COF.

FIGS. 7A-7C illustrate a computer block diagram flow chart for a measurement system of the apparatus of the invention.

### DETAILED DESCRIPTION OF THE INVENTION

These and other objects and advantages of the present invention will become more apparent to those skilled in the art in view of the following description and the accompanying drawings wherein like parts and objects have similar reference numerals. It is to be understood that the inventive concept is not to be considered limited to the constructions disclosed herein but instead by the scope of the appended claims.

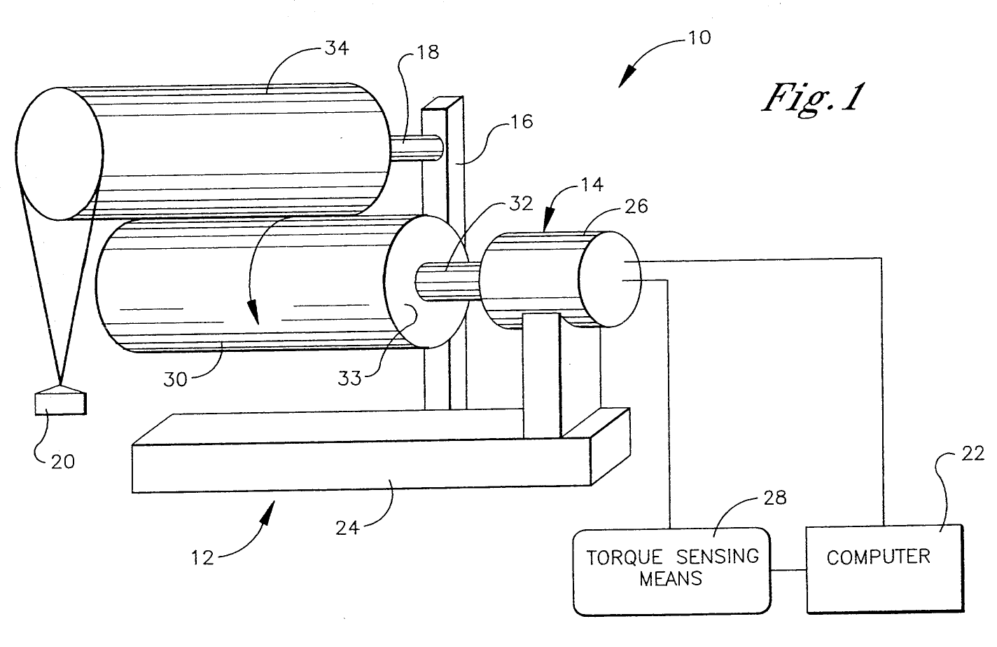

Referring to FIG. 1 a first embodiment of the bottle friction analysis system is illustrated and is useful for measuring the frictional characteristics and more particularly, the static and kinetic coefficient of friction of plastic bottles or preforms in contact with other bottles or preforms. The apparatus 10 is an assemblage cooperatively positioned for determining the coefficient of friction and includes: a frame 12 for supporting and positioning bottles; a torque generating means 14, which desirably is attached to the frame 12; a means for holding a sample stationary having substantially vertical member 16 attached to the frame 12 and a rod member 18 attached to the vertical member 16; a variable weight or force means 20; and a computer control assembly 22 which serves to automatically control on/off operations, motor speed, as well as, subsequent recording and calculations of torque. Optionally, the computer assembly 22 can provide an output of the data either visually, on paper, or both as well as make adjustments to test parameters, if needed.

Describing the apparatus and method of the invention in greater detail, the frame 12 is desirably made from a solid material having sufficient density and tensile strength to ensure stability of the parts supported by the base to resist flexure during operation. Suitable materials include metals and reinforced plastics. The frame 12 has a base 24 that may be made as a rigid, hollow, box-like structure that is attached, either permanently or removably, to a stationary bench or table, not shown.

The torque generating means 14 includes a motor 26 having an encoder, for determining speed of rotation, interfaced to the computer 22. Computer control provides rotation at pre-selected constant speeds, while a torque sensing device 28 attached to the motor 26 provides a voltage readout that is an indication of the torque exerted by rotating a first bottle 30, as described in greater detail below. The torque-sensing device 28 that is attached to the torque generating means 14 is also referred to in the industry as a synthetic tachogenerator which is a torque and/or speed sensing device which produces an output voltage that is proportional to the torque exerted or speed of the motor. The computer 22 control serves to automatically control on/off operations, motor speed, as well as, to record the torque and calculate the coefficient of friction, do statistical analysis and display the data on a computer screen.

The first bottle 30 is a typical blown plastic bottle or preform or parison, used to blow-mold bottles suitable for containing carbonated beverages, purified water or juices. The first bottle 30 is removably attached to the motor 26 by a driven means 32, such as a metal screw cap 33 on one end of the motor's shaft.

The stationary sample holder means includes a vertical member 16 which, like the base 24, is desirably made from a material having a high tensile strength, such as metal or a reinforced plastic. In a preferred embodiment, the vertical member 16 may be movably adjusted in at least one plane, i.e., along the frame member 12 in the plane that is substantially parallel to the longitudinal axis of the first bottle 30, and in a more preferred embodiment, the vertical member 16 is adjustable in two planes, i.e., along a plane that is substantially parallel to the longitudinal axis of the first bottle 30 and in the plane that is substantially perpendicular to the longitudinal axis of the first bottle 30. The latter motion may be accomplished by an upper portion of the vertical member 16 telescoping over at least part of a lower portion. Although it is preferred that the vertical member 16 be allowed to float or move freely along its axis, one may include a locking means for retaining the vertical member 16 at the desired setting or position. Such locking means may be a screw, bolt or pressure coupling. As used herein the terms “substantially parallel” and “substantially perpendicular” mean that the angle between the plane and the longitudinal axis is within 20 degrees of being parallel or perpendicular and more preferably is within 5 degrees of being parallel or perpendicular.

Rod member 18 may be either fixedly or movably attached to the vertical member 16. The rod member 18 may be movably affixed to the vertical member 16 in a manner that allows the second or fixed bottle 34 to move in one plane, i.e., along a second axis that is perpendicular to the longitudinal axis of the first bottle 30. Accordingly, the rod member 18 may be movably affixed to the vertical member 16 in a manner that allows the second bottle 34 to pivot upwardly, or is adjustable along the longitudinal axis of the rod member 18 via use of a sleeve over the rod member, or both, thus giving the stationary sample holder means the ability to move in three planes relative to the first bottle 30.

The second bottle 34 is affixed to the rod member 18 in a manner that is identical to the first bottle 30 described above.

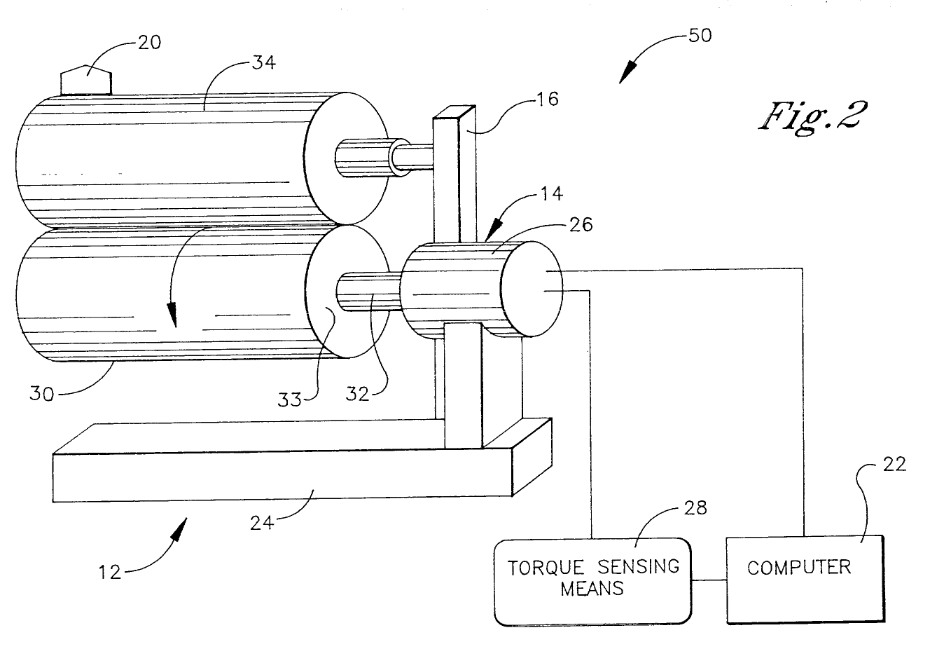

Acting upon the second bottle 34 is the force means 20 to keep the second bottle in contact against the first bottle during rotation and so that a selected load can be applied to the sample in a direction normal to the friction surface. The force means, as illustrated in FIGS. 1 and 2, may be a weight that is positioned adjacent to an end of the second bottle 34, either by suspending the weight from a cord, wire, or other means or by being placed on a platform on top the fixed bottle that can be removably stacked to selectively vary the load applied to the sample. Alternatively, the weight can be configured to have a hole for slipping the weight over the end of the fixed bottle 34. In an alternative embodiment, not shown, the force means may be a pressure device adapted to apply a downward pressure or force on the second bottle 34. Such device may include a hydraulic or pneumatic pressure means having a rod connected to an actuating cylinder for holding a constant downward pressure on the second, fixed bottle. It is also within the scope of the present invention for the force means to be a fluid cylinder that is moved to different positions to selectively vary the load applied wherein the computer 22 controls the variable weight loading.

The torque sensing means 28 also referred to in the industry as a synthetic tachogenerator which is a torque and/or speed sensing device which produces an output voltage that is proportional to the torque or speed of the rotating bottle 30 in contact with the fixed bottle 34. Either analog or digital tachogenerators can be used with corresponding control means to achieve substantially the same result. In a preferred embodiment, a digital tachogenerator provides the output voltage. The tachogenerator automatically adjusts the torque to maintain a constant speed once the bottles are in motion from a standstill.

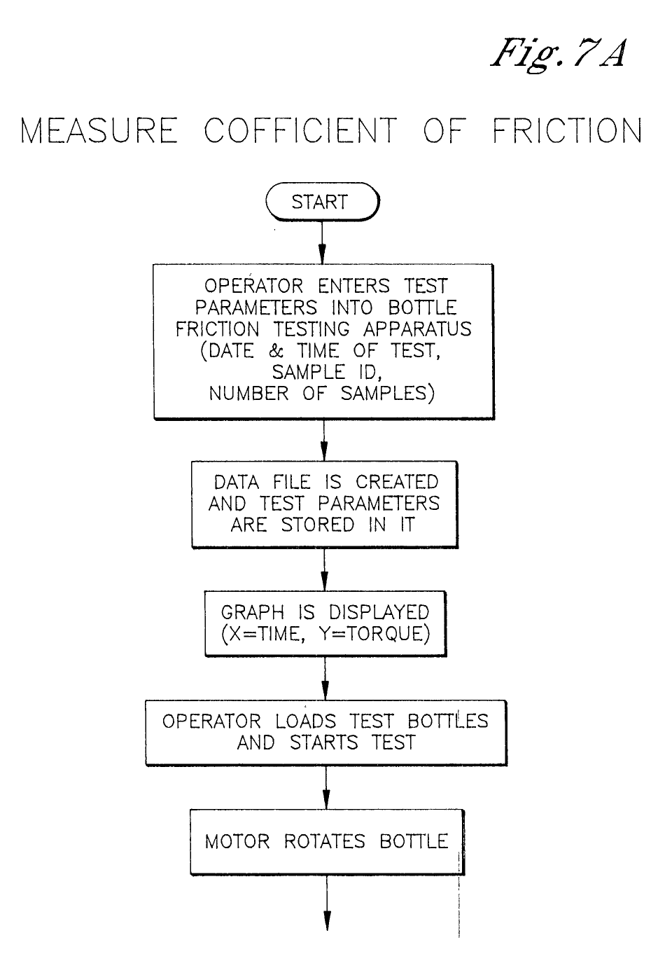

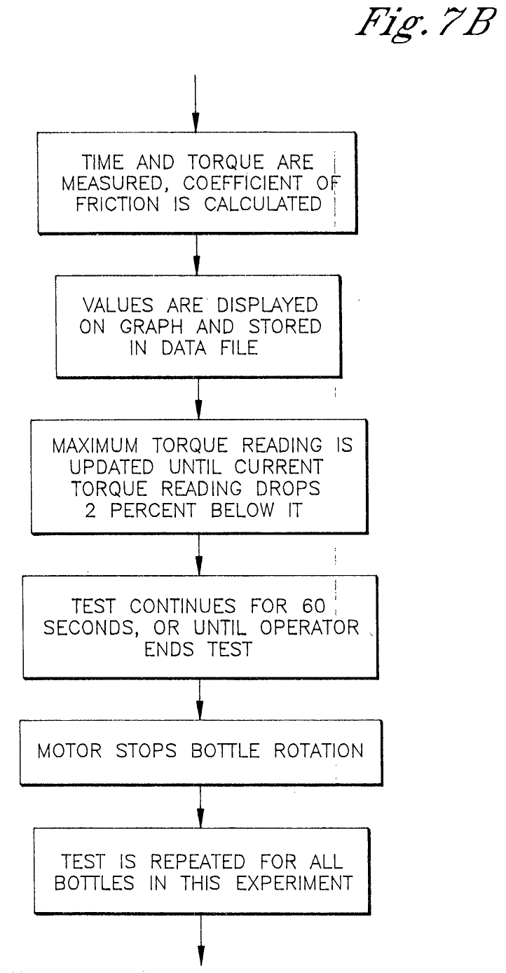

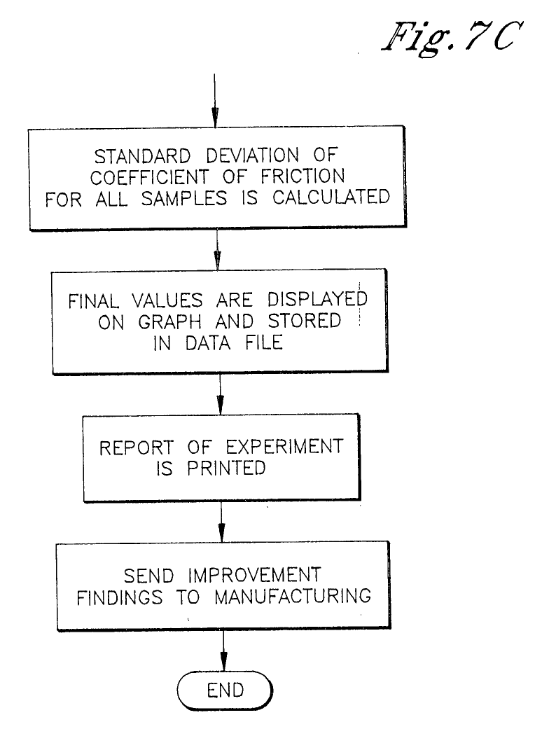

The computer 22 is connected to the torque sensing means 28. The computer 22 serves to automatically control on/off operations, motor speed, as well as, to record the torque and calculate the coefficient of friction, do statistical analysis and display the data on a computer screen. The computer 22 can be conventional microcomputer suitably programmed to carry out the various control functions of the system. For example, FIGS. 7A-7C show an embodiment of a program flow chart. The computer 22 may be programmed to query the operator for sample ID; write data to a data file; display a graph of torque vs. time over a predetermined time or interval; determine the maximum torque over a the predetermined time or interval; calculate the coefficient of friction; and display the output either graphically on a monitor screen, print a report or both. Optionally, the computer 22 may be programmed to make certain parameter changes in test model for subsequent test specimens. Such programming is within the ordinary skill of someone in the programming art.

The coefficient of friction (μ) is calculated by the computer 22 using the formula:

μ=(Torque/R)/F₂

where Torque is the output torque recorded by sensing device 28, R is the first bottle 30 radius, and F₂ is the load experienced by bottles at their contact point determined by the formula:

F₂=F₁(L₁/L₂).

where F₁ is the load or weight applied to the fixed bottle 34, L₁ is the distance from the fixed bottle 34 pivot point to the point where the weight is applied, and L₂ is the distance from the fixed bottle 34 pivot point and the contact point between the bottles. The computer controlled analysis system is capable of continuously measuring the frictional characteristics of plastic bottles, and is quite useful in providing a quantitative measure of the frictional characteristics of plastic articles.

Referring to FIG. 2, another embodiment of the bottle friction analysis system 50 is illustrated. The bottle friction analysis system 50 is similar to that described above except that the first and second bottles, 30 and 34 respectively, are arranged in a parallel orientation to simulate upright contact such as when the bottles are being conveyed to a filling station after the preforms are blow-molded to their predetermined fill volume. In order to prevent the collapse of bottles when they are placed in contact with each other, a rubber gasket may be used in the screw caps to maintain an internal pressure.

In operation, the motor 26 of the torque generating means 14 is at rest and the first bottle 30 is fixedly attached or mounted to the motor shaft 32. The second bottle 34 is fixedly attached to rod member 18 and the first and second bottles are positioned so that an outer surface of the first bottle 30 is in contact with an outer surface of the second bottle 34. A known downward force is applied to the second bottle 34 for holding the first and second bottles in intimate contact. Torque is progressively applied to first bottle 30 and the amount of torque is monitored. The computer 22 increases the torque applied to the first bottle 30 via motor 26 until slip is detected by the torque sensing means 28 and/or the torque necessary for retaining a constant speed is recorded. The torque sensing means 28 detects the torque applied and is registered by the computer 22 which records the data and controls the speed of the motor 26. The computer 22 is programmed to calculate the coefficient of friction and provides an output, such as displaying a graph, printing a report, and/or making adjustments to test parameters. During testing, the bottle friction analysis system measures and registers the parameters of testing. Depending on the type of testing, the following parameters can be measured: a coefficient of friction, friction torque, friction force, abrasive wear of the specimens, and stick/slip characteristics. Stick/slip characteristics can be measured by detecting moments of friction sticking and by measuring the force and torque at which the sticking is overcome and relative movement is resumed.

The present invention is illustrated in greater detail by the specific examples presented below. It is to be understood that these examples are illustrative embodiments and are not intended to be limiting of the invention, but rather are to be construed broadly within the scope and content of the appended claims.

The following examples provide a measure for the variation expected for bottle friction testing and static coefficient of friction using the bottle configuration shown in FIG. 1. Static coefficient of friction, as used herein, is defied as the maximum friction force that must be overcome in order to initiate motion between two bodies. The following examples measured (1) coefficient of friction test variability, (2) effect of initial motor rotation speed setting on coefficient of friction, (3) effect of applied loading or force applied to bottles on coefficient of friction, (4) effect of bottle aging time or time after bottle is formed on coefficient of friction, and (5) effect of denesting agent on COF.

### EXAMPLE 1

### Test Variability of Static Coefficient of Friction

In accordance with the present invention, measurement of COF test variability was made by testing 4 pairs of 20 ounce bottles (0.6 liter) and using the averages for each data point. The results of variable bottle rotation speed and bottle loading are in Table I below. Bottle rotation speed refers to the motor speed control setting prior to test activation. This motor speed determines the rate and final speed at which the motor will rotate.

TABLE I

| | | Motor Speed | | |
|---|---|---|---|---|
| Run | Weight | Setting (rpm) | Sample | COF |
| 1 | 500 | 10 | 1 | 1.187 |
| 1 | 500 | 10 | 2 | 1.143 |
| 1 | 500 | 10 | 3 | 1.514 |
| 1 | 500 | 10 | 4 | 1.365 |
| 2 | 100 | 10 | 2 | 1.237 |
| 2 | 100 | 10 | 3 | 1.336 |
| 2 | 100 | 10 | 4 | 1.138 |
| 3 | 500 | 10 | 1 | 1.464 |
| 3 | 500 | 10 | 2 | 1.192 |
| 3 | 500 | 10 | 3 | 1.598 |
| 3 | 500 | 10 | 4 | 1.331 |
| 4 | 200 | 10 | 1 | 1.694 |
| 4 | 200 | 10 | 2 | 1.385 |
| 4 | 200 | 10 | 3 | 0.495 |
| 4 | 200 | 10 | 4 | 1.707 |
| 5 | 1000 | 10 | 1 | 0.975 |
| 5 | 1000 | 10 | 2 | 1.177 |
| 5 | 1000 | 10 | 3 | 1.081 |
| 5 | 1000 | 10 | 4 | 1.202 |
| 6 | 500 | 10 | 1 | 1.395 |
| 6 | 500 | 10 | 2 | 1.074 |
| 7 | 500 | 10 | 1 | 1.187 |
| 7 | 500 | 10 | 2 | 1.469 |
| 7 | 500 | 10 | 3 | 1.301 |
| 7 | 500 | 10 | 4 | 1.474 |
| 8 | 500 | 40 | 1 | 0.985 |
| 8 | 500 | 40 | 2 | 1.049 |
| 8 | 500 | 40 | 3 | 1.088 |
| 8 | 500 | 40 | 4 | 0.821 |
| 9 | 500 | 5 | 1 | 1.43 |
| 9 | 500 | 5 | 2 | 1.42 |
| 9 | 500 | 5 | 3 | 1.45 |
| 9 | 500 | 5 | 4 | 1.529 |
| 10 | 500 | 20 | 1 | 1.158 |
| 10 | 500 | 20 | 2 | 1.103 |
| 10 | 500 | 20 | 3 | 0.9 |
| 10 | 500 | 20 | 4 | 0.747 |
| 11 | 500 | 40 | 1 | 0.925 |
| 11 | 500 | 40 | 2 | 0.9 |
| 11 | 500 | 40 | 3 | 0.792 |
| 11 | 500 | 40 | 4 | 0.722 |
| 12 | 500 | 10 | 1 | 0.757 |
| 12 | 500 | 10 | 2 | 1.163 |
| 12 | 500 | 10 | 3 | 1.182 |
| 12 | 500 | 10 | 4 | 1.163 |
| 13 | 500 | 2 | 1 | 1.672 |
| 13 | 500 | 2 | 2 | 1.484 |
| 13 | 500 | 2 | 3 | 1.499 |
| 13 | 500 | 2 | 4 | 1.405 |
| 14 | 500 | 5 | 1 | 1.138 |
| 14 | 500 | 5 | 2 | 0.866 |
| 14 | 500 | 5 | 3 | 1.009 |
| 14 | 500 | 5 | 4 | 1.459 |

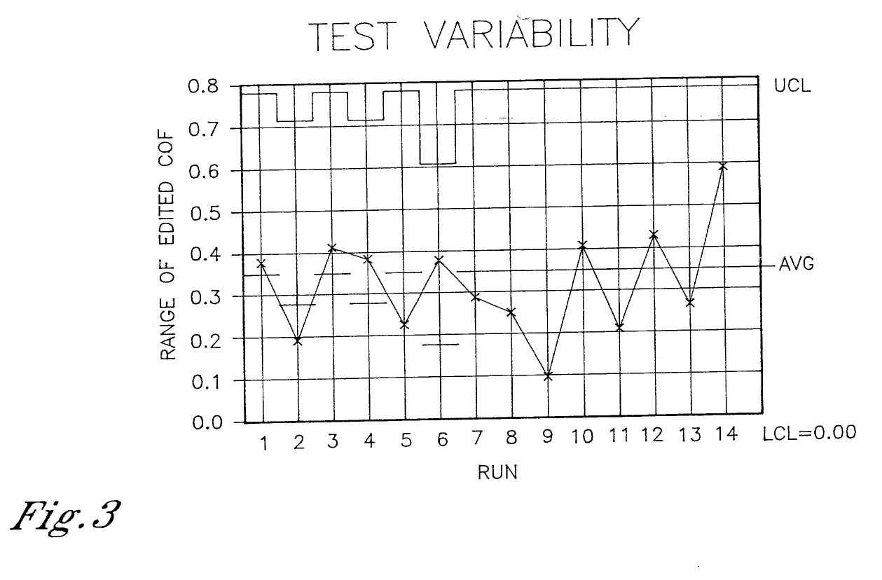

This example shows that when testing 4 pairs of bottles, the range of a set of 4 bottles tested should not be larger than 0.8, as determined from range charts. The results are illustrated in FIG. 3.

### EXAMPLE 2

### Effect of Motor Rotation Speed Setting on COF

Using averages, the effect of motor rotation speed on measured static coefficient of friction was made by testing 4 pairs of 20 oz. (0.6 liter) bottles and a 500 gram weight. Test results are in Table II below.

TABLE II

| Run | rpm | n | COF Average | COF Std. Dev. |
|---|---|---|---|---|
| 1 | 10 | 4 | 1.30225 | 0.170703 |
| 2 | 10 | 4 | 1.39625 | 0.174422 |
| 3 | 10 | 2 | 1.2345 | 0.226981 |
| 4 | 10 | 4 | 1.35775 | 0.139364 |
| 5 | 40 | 4 | 0.98575 | 0.117755 |
| 6 | 5 | 4 | 1.45725 | 0.049433 |
| 7 | 20 | 4 | 0.977 | 0.189267 |
| 8 | 40 | 4 | 0.83475 | 0.094768 |
| 9 | 10 | 4 | 1.06625 | 0.206361 |
| 10 | 2 | 4 | 1.515 | 0.112496 |

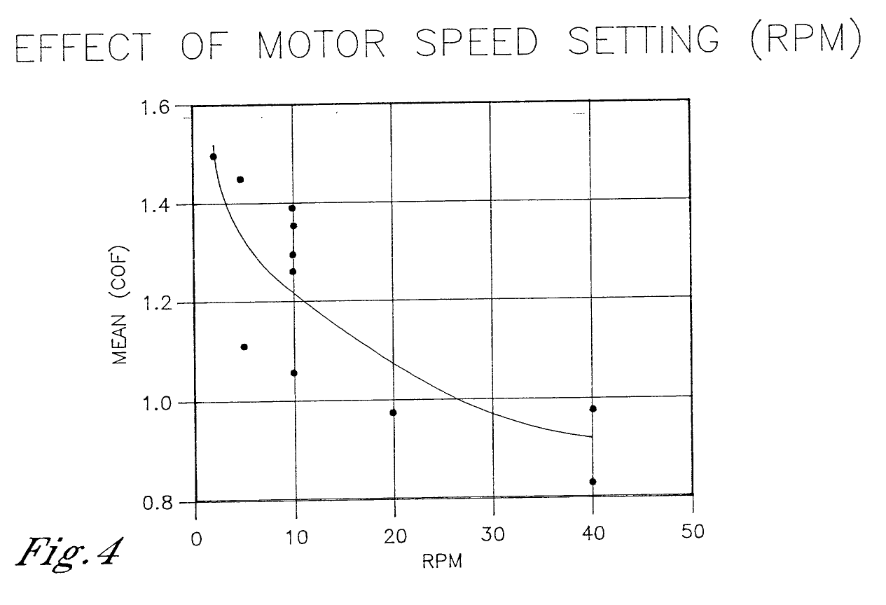

FIG. 4 is a plot of mean COF vs. motor rotation speed setting (rpm). The data indicates that bottle rotation speed has a significant effect on measured static coefficient of friction.

### EXAMPLE 3

### Effect of Variable Applied Loading

This example was to determine the effect of applied loading or force experienced by bottles on coefficient of friction. The 20 oz. (0.6 liter) bottles were rotated at a speed of 10 rpm. The results are in Table III below.

TABLE III

| Run | Weight (gr.) | n | COF Average | COF Std. Dev. |
|---|---|---|---|---|
| 1 | 500 | 4 | 1.3023 | 0.1707 |
| 2 | 100 | 4 | 1.2370 | 0.0990 |
| 3 | 500 | 4 | 1.3963 | 0.1744 |
| 4 | 200 | 4 | 1.5953 | 0.1823 |
| 5 | 1000 | 4 | 1.1088 | 0.1033 |
| 6 | 500 | 2 | 1.2345 | 0.2270 |
| 7 | 500 | 4 | 1.3578 | 0.1394 |

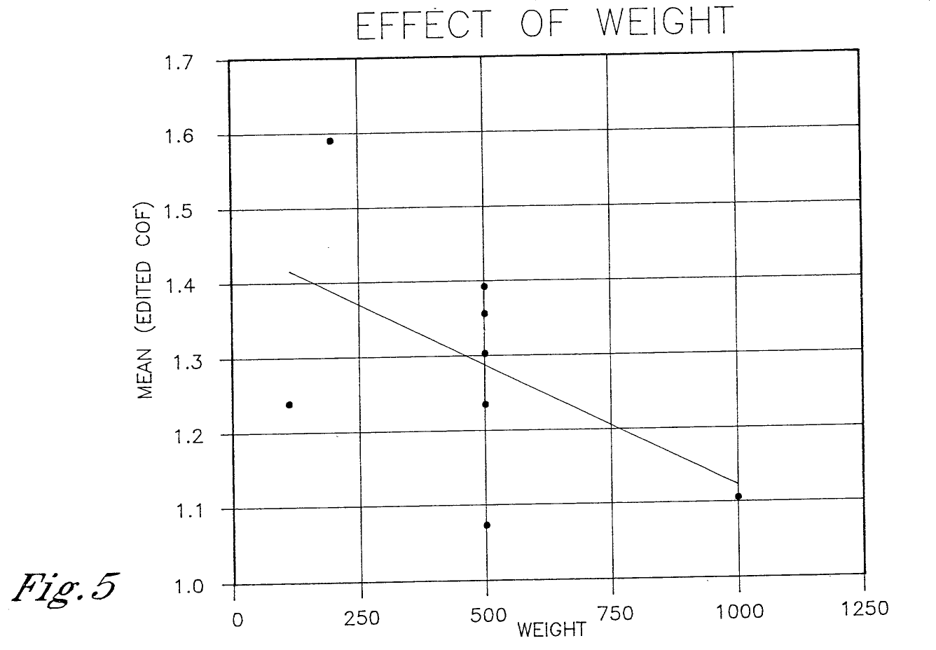

FIG. 5 is a plot of mean COF vs. applied loading (in grams). The data indicates that weight does not have a significant effect on measured coefficient of friction.

### EXAMPLE 4

### Effect of Bottle Aging Time on COF

The effect of time on the coefficient of friction was evaluated. Time was measured in minutes after stretch-blow-molding 20 oz (0.6 liter) bottles. The results are in Table IV below.

TABLE IV

| Time (min) | n | COF Average | COF Std. Dev. |
|---|---|---|---|
| 0 | 44 | 1.512614 | 0.177343 |
| 10 | 4 | 1.660667 | 0.183533 |
| 20 | 4 | 1.55375 | 0.154733 |
| 30 | 4 | 1.57975 | 0.224087 |
| 45 | 4 | 1.444 | 0.189091 |
| 80 | 4 | 1.501 | 0.316778 |
| 110 | 4 | 1.33125 | 0.201688 |
| 170 | 4 | 1.40325 | 0.106155 |

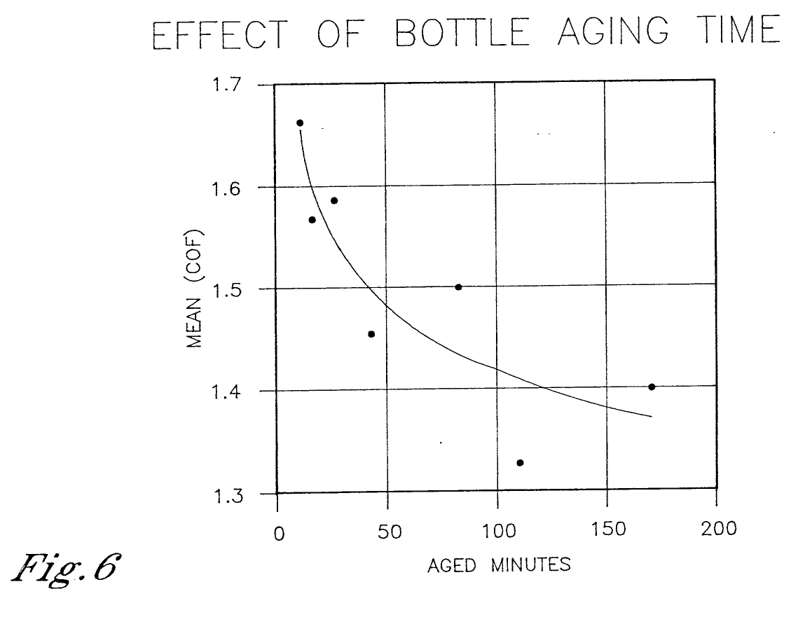

FIG. 6 is a plot of mean COF vs. aging time. The data indicates that aging time has a significant effect on coefficient of friction.

### EXAMPLE 5

This example demonstrates how the apparatus of the present invention can be used to establish resin composition and particularly the amount of an antiblocking agent necessary to obtain an acceptable coefficient of friction for a thermoplastic material. An antiblocking agent, Polar talc 9107 (7 micron) was dried to approximately 250 ppm moisture and then added to a PET reaction mixture comprising terephthalic acid, isophthalic acid, and ethylene glycol commercially available from Eastman Chemical Company as ESTAPAK® CSC Resin. Two-liter preforms for PET bottles were made by injection molding pellet/pellet blends on an eight cavity Husky injection molding machine. The preforms were stretch blown on a SIDEL 2/3 stretch blow molding machine into 2-liter bottles. All bottles were tested after approximately 3 hrs after stretch-blow-molding. Bottles were analyzed for coefficient of friction by mounting two bottles perpendicular, as illustrated in FIG. 1, under the following test conditions: 500 gram load and motor speed set a 10 rpm. The results are shown in Table V below.

TABLE V

| Example | wt % Talc | Talc, Dried | COF |
|---|---|---|---|
| 1 | 0 | Control Sample | 1.28 |
| 2 | 0.01 | Dried | 0.35 |
| 3 | 0.015 | Dried | 0.25 |
| 4 | 0.02 | Dried | 0.26 |
| 5 | 0.025 | Dried | 0.22 |
| 6 | 0.03 | Dried | 0.22 |
| 7 | 0 | Control Sample | 1.19 |
| | (repeat) | | |
| 8 | 0.01 | Dried | 0.27 |
| | (repeat) | | |
| 9 | 0 | Control Sample | 1.44 |

As can be seen from the above data, the apparatus of the present invention is useful in developing new polymer resins having a reduced coefficient of friction or a particular target or range of coefficient of friction.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

We claim:

1. An apparatus for measuring the coefficient of friction of a material comprising:
a frame member;
means for holding a sample stationary affixed to the frame member;
a torque means;
means for holding a rotatable sample affixed to the torque means;
means for applying a force to a stationary sample affixed in said stationary holding means and in frictional engagement with a rotatable sample affixed in said rotatable sample holding means during the relative movement between the stationary sample and rotatable sample and for applying a predetermined load to the stationary sample in a direction that is normal to the rotatable sample;
torque sensing means attached to the torque means; and
computer means for controlling said torque means, recording torque measurements from said torque sensing means and calculating the coefficient of friction.

2. The apparatus of claim 1 wherein said stationary sample holder means comprises a screw cap attached to a rod member, which is affixed to a substantially vertical member, which is affixed to said frame member.

3. The apparatus of claim 2 wherein said stationary sample holder means is moveable in one plane.

4. The apparatus of claim 2 wherein said stationary sample holder means is moveable in two planes.

5. The apparatus of claim 2 wherein said stationary sample holder means is moveable in three planes.

6. The apparatus of claim 3 wherein said rod member is upwardly pivotable.

7. The apparatus of claim 3 wherein said rod member is upwardly pivotable and said substantially vertical member is adjustable along the plane that is substantially parallel to a longitudinal axis of the rotatable sample.

8. The apparatus of claim 3 wherein said substantially vertical member is adjustable along the plane that is substantially perpendicular to a longitudinal axis of the rotatable sample.

9. The apparatus of claim 4 wherein said substantially vertical member is adjustable along the plane that is substantially parallel to a longitudinal axis of the rotatable sample and along the plane that is substantially perpendicular to a longitudinal axis of the rotatable sample.

10. The apparatus of claim 1 wherein said torque means is a motor.

11. The apparatus of claim 10 wherein said means for holding a sample affixed the torque means comprises a screw cap attached to a shaft of said motor.

12. The apparatus of claim 1 wherein said means for applying a force to said stationary sample is a weight.

13. The apparatus of claim 13 wherein said weight is suspended from said stationary sample.

14. An apparatus for measuring the coefficient of friction of a material comprising:
a frame member;
means for holding a stationary sample affixed to the frame member comprising a screw cap attached to a rod member, which is affixed to a substantially vertical member, which is affixed to a substantially vertical member which is attached to said frame member;
a torque means;
means for holding a rotatable sample affixed the torque means;
means for applying a force to a stationary sample affixed in said stationary holding means and in frictional engagement with a rotatable sample affixed in said rotatable sample holding means during the relative movement between the stationary sample and rotatable sample and for applying a predetermined load to the stationary sample in a direction that is normal to the rotatable sample;
a torque sensing means attached to the torque means; and
computer means for controlling said torque means, recording torque measurements from said torque sensing means and calculating the coefficient of friction.

15. The apparatus of claim 14 wherein said rod member is upwardly pivotable and said substantially vertical member is adjustable in one plane.

16. The apparatus of claim 14 wherein said substantially vertical member is adjustable in two planes.

17. The apparatus of claim 16 wherein said substantially vertical member is adjustable along the plane that is substantially parallel to a longitudinal axis of the rotatable sample and along the plane that is substantially perpendicular to a longitudinal axis of the rotatable sample.

18. The apparatus of claim 15 wherein said means for applying a force to said stationary sample is a weight.

19. A method for determining the coefficient of friction of a material comprising:
providing the apparatus of claim 1;
securing a first sample to the stationary sample holding means;
securing a second sample to the rotatable sample holding means;
applying a predetermined downward force to said stationary sample;
progressively applying and monitoring the torque applied to the second sample; and
calculating the coefficient of friction.

20. The method of claim 19 further comprising providing an output selected from displaying a graph, printing a report, and adjusting test parameters.
